(19) United States
(12) Patent Application Publication
(10) Pub. No.: US 2023/0242382 A1
(43) Pub. Date: Aug. 3, 2023

(54) METHOD FOR CONTROLLING A CRANE ACCORDING TO A REAL TIME EVOLVING INTERFERENCE MAP

(71) Applicant: MANITOWOC CRANE GROUP FRANCE, DARDILLY (FR)

(72) Inventor: François LEMIRE, Soucieu En Jarrest (FR)

(21) Appl. No.: 18/163,279

(22) Filed: Feb. 1, 2023

(30) Foreign Application Priority Data
Feb. 1, 2022 (FR) 2200881

(51) Int. Cl. B66C 13/48; B66C 23/88

(52) U.S. Cl. CPC B66C 13/48; B66C 23/88; B66C 2700/084

(57) ABSTRACT

A method for controlling a crane having a boom operating in a circular work area and at least one anti-collision system detecting a risk of collision on a right side and a left side of the boom may be used to direct the boom from a starting angular sector, where a risk of collision with an obstacle has been detected, towards a final angular sector where a risk of interference is low or even zero, based on an interference mapping segmenting the circular work area into several angular sectors and associating with each of them an interference counter value representative of a level of risk of interference. The values may evolve in real time according to the orientations of the boom and collision risk detections.

### FIELD

The invention generally relates to the technical field of cranes, and in particular tower cranes. The invention also relates to a control system executing this control method, and to a crane equipped with said control system.

The invention relates more particularly to a crane control method, for which the boom of the crane is controllable in an automated control state with the aim of avoiding colliding with neighboring obstacles, in particular the booms of the neighboring cranes.

The invention may thus find a non-limiting application on the sites in which at least two cranes are installed and used, the booms of which operate in intersecting working circular areas.

### BACKGROUND

As is known, it may be necessary to install and use several cranes on a site to cover, because of its relief and its extent, the entire construction area, and/or to achieve the objectives targeted by the application context. However, depending on the locations where the cranes are mounted and the tasks assigned to them, it is possible that their fields of action, which describe a circular area, partially overlap. The problem raised by these overlap zones, called the interference zones, is that there is a higher or lower risk that the cranes sharing an interference zone may, during their orientation movement, be interfering in this so-called interference zone, and in the worst case colliding.

In the case that the presence of interference zone is unavoidable, the managers of the site must imperatively and compulsorily equip the cranes with safety devices preventing these risks of interference and collision, such as: collision avoidance systems continuously monitoring and detecting whether, in its orientation movement, the boom of the crane will or will not encounter an obstacle (like the boom of another crane); or working space/travel limiters, for example orientation limiters. Generally, this equipment is connected and communicates with the control/command system of the crane, which controls its orientation movements.

On such sites, when all the crane operators have left their control stations, it is conventional to place all the cranes in a weather vane or out of service state, in which for each the orientation brake is released and the boom is free to turn under the action of the wind, thus aligning itself naturally in the wind.

However, in the particular case where one of the cranes is at working state with a crane operator operating, and where the crane operator of a neighboring crane is not at his control station, it is then necessary, and known, to place this neighboring crane in a state of automated control of the orientation of its boom, so that the latter does not interfere with the boom of the crane at working state.

Numerous automated control methods which are executed by the control/command system with a view to automatically orienting the boom so as to limit, or even eliminate, any risk of interference, in at least one interference zone, are available in the literature, such as those cited below.

The document EP3495311 discloses an automatic control method having to either: position a crane in an optimal configuration, which corresponds to a spatial configuration in which the crane is in alignment with the direction of the wind, if to reach this optimal configuration, the crane must not cross interference zones; or else, in the case that the crane has to cross at least one interference zone, first determining subsidiary configurations attached to subsidiary angular sectors that do not intersect the interference zones, then positioning the crane in the subsidiary configuration that is closest to the optimal configuration, that is to say the subsidiary configuration for which the boom of the crane will be most in phase with the direction of the wind, if not perfectly aligned therewith.

The document EP3495310 discloses an automatic control method which determines a preferred direction of rotation, corresponding to the direction of rotation for which the crane has the least interference zone to cross when it is brought to be displaced from an initial configuration to a destination configuration aligned with the wind.

The document JPH07300295 proposes a method for which two cranes communicate with each other in order to know the orientations and the relative elevations of their respective booms, and thus define safety zones, without having to use collision avoidance system.

However, for these automatic control methods to be carried out in practice, the operators must, during a preparatory phase prior to the launch, configure the control/command systems by entering/defining the locations of the various cranes present on their site, as well as the interference zones which will depend on characteristics entered by the operator and relating to the locations of the present various cranes and/or to the dimensions of their elements/equipment, for example, the length of the booms or counter-booms.

Thus, this preparatory phase can be long and/or complex to implement (both technically and materially), and prone to errors because it is based on data entered by the operator(s). It also requires, for the configuration of the control/command system, the intervention of a person who masters the environmental context of the site (relief of the site, the different states and equipment of a crane, etc.), the all people working on a site who do not necessarily have the same approach/knowledge of the site (a person in charge of managing the entire site will, for example, have a finer knowledge or a more global vision than a crane operator in charge of a crane among the several present). Moreover, the configuration of the control/command system, depending on how it was thought out/defined, may prove to be not very intuitive and ergonomic for a person who does not master computer tools (for example, because of the number of parameters to be entered).

### SUMMARY

Also, the invention aims to positively respond to this problem by proposing a highly accessible control method capable of independently controlling the orientation of a crane boom according to the risk levels of the interference zones comprised in its circular work area, without it being necessary to specify the environmental context; the control method discovering and memorizing, in real time, the interference zones in order to then adapt to them and optimize future boom orientation movements which will reduce or even eliminate the risks of interference and collision.

Thus, the invention proposes a control method for controlling a crane comprising a boom and at least one anti-collision system suitable for detecting a risk of collision on a right side and a left side of the boom, said boom being controllable by orientation about an orientation axis and operating in a circular work area, for which the crane is:
either in a working state for which a manual controlling of the orientation of the boom is implemented by a crane operator,
either in an automated control state for which an automated controlling of the orientation of the boom is implemented;

the control method implementing at least the following steps:
an initial segmentation step during which the circular work area is segmented into several angular sectors;
an initial setting step during which each of the several angular sectors is associated with an interference counter representative of a level of risk of interference in the associated angular sector between the boom and an obstacle;
a construction step during which, the crane being either in the working state or in the automated control state, whether the boom is moving or not, and each time the boom is present in an angular sector among the several angular sectors, and the at least one anti-collision system detects a risk of collision in said angular sector, then a value of the interference counter in said angular sector is incremented, thus constructing in real time an interference mapping in which the several angular sectors present interference counters having values which are distinct and progressive.

The principle of the control method of the invention is based on the use of an interference mapping representative of the circular work area of the crane, which circular work area being segmented into a plurality of angular sectors. Each angular sector is associated with an interference counter whose value is representative of a level of interference risk (and therefore possibly of collision) in this angular sector between the boom and an obstacle (such as the boom of another crane). For example, if the value of the interference counter is low (even zero), then the risk of interference between the boom and an obstacle is low (even zero). Conversely, the higher the value of the interference counter, the greater the risk of interference.

The particularity of this mapping is that it changes in real time such that when the at least one anti-collision system with which the crane is equipped, which is located in any angular sector, detects a risk of collision between the crane and an obstacle, the value of the interference counter of this angular sector is incremented.

An advantage of this method is that it is not necessary to have a preparatory phase of knowing and entering the environmental context of the site, insofar as the method is implemented autonomously by the crane with a learning in real time of the levels of interference risk in the angular sectors segmenting its circular work area for its orientation and positioning. Thus, it is not useful to know the number and location of the cranes whose field of action may interfere with that of the crane for which the method is implemented, nor the condition of said cranes (working, in automatic mode, in weather vane, etc.). Also, the mapping is built independently of the state of the considered crane.

Moreover, as explained below, a default mapping of the circular work area is proposed, for which the circular work area is segmented into a predefined number of angular sectors such, for all the angular sectors, the level of interference risk is minimal. In this case, the control method will completely autonomously identify, depending on the cases occurring in the circular work area, the angular sectors of interference and their associated level of interference risk. Advantageously, the initial segmentation and setting steps are not a compulsory step for the operator, and they are above all not blocking if this operator is not aware of the environment context of the crane.

However, in the opposite case, the operator has the option of defining the number of angular sectors must segment the circular work area and assigning all or part of them an interference counter value. Thus, the method is highly accessible by being able to be executed as much by people with or without knowledge relating to the characteristics of the site, as by people who have mastered or are reluctant to use computers. It should be noted that these optional initial steps of segmentation and setting are implemented only once, at the time of commissioning of the method.

It should also be noted that the segmentation of the circular work area is a theoretical or virtual segmentation, associated with a model of the circular work area. In other words, the control method builds a model of the circular work area, representative of the circular work area of the crane, and on this model it implements the segmentation.

According to a characteristic of the invention, when the crane is in the automated control state, the automated controlling of the orientation of the boom is implemented as a function of the interference mapping.

Advantageously, when the crane is in the automated control state, the control method is adapted in real time to changes in the interference mapping to orient and then position the crane in angular sectors in which the interference risk is low/lower.

According to a characteristic of the invention, during the automated controlling, each time the boom is present in an angular sector, called the starting angular sector, among the several angular sectors, and the at least one anti-collision system detects a risk of collision in said starting angular sector, an automatic and autonomous orientation step of the boom is implemented during which said boom is oriented from the starting angular sector in a direction opposite to the right or left side for which is detected the risk of collision, until being automatically stopped in a final angular sector which is an angular sector in which the at least one anti-collision system does not detect any risk of collision, said automatic and autonomous orientation step of the boom comprising a selection sub-step during which the final angular sector is selected among the several angular sectors as a function of the values of their respective interference counters.

When a risk of collision is detected by at least one anti-collision system between the boom of the crane and an obstacle, which may arrive from the right side or the left side of the boom, and the boom is in an automated controlling, the control method, during a so-called automatic and autonomous orientation step, will automatically carry out an orientation movement of the boom of the crane in the opposite direction to that of the side of the boom where the collision risk has been detected, from the angular sector where the boom of the crane is located, called the starting angular sector, to a final angular sector where the crane will be stopped and in which the at least one detection system will no longer detect the collision risk.

Advantageously, the orientation movement is carried out by the control method in complete autonomy, that is to say that the crane, when a risk of collision is detected with an obstacle such as the boom of another crane, does not need to communicate with this other crane to perform the boom orientation movement, hence its autonomous nature.

The final angular sector is selected by the control method, during a selection sub-step taking place during the step of automatic and autonomous orientation of the boom, among several angular sectors, relying for this on the interference mapping giving at time t the interference counter values of each of these angular sectors, the objective being to position the boom of the crane in an angular sector in which the interference risk is low.

According to a characteristic of the invention, during the step of automatic and autonomous orientation of the boom, the boom is oriented from the starting angular sector until it reaches or exceeds a precautionary angular sector, said precautionary angular sector corresponding:
either to the angular sector, called the first angular sector, for which the at least one anti-collision system no longer detects any risk of collision during the step of automatic and autonomous orientation of the boom from the starting angular sector;
or to an angular sector located at a precautionary angular distance from said first angular sector.

In other words, during the automatic orientation of the boom of the crane by the method for controlling the starting angular sector towards the final angular sector, the boom will at least reach a so-called precautionary angular sector in which the at least one collision avoidance system no longer detects the risk of collision. Note that during this orientation, if there is at least one intermediate angular sector comprised between the starting angular sector and the precautionary angular sector, the interference mapping will be updated in real time such that the values of the interference counter of the starting angular sector and of this at least one intermediate angular sector will be incremented. Since the risk of collision is no longer detected in the precautionary angular sector, its interference counter value remains unchanged.

According to a variant of the method, this precautionary angular sector may correspond to the angular sector, called the first angular sector, for which the risk of collision is no longer detected. According to a second variant, in order to leave an additional safety margin to further minimize the interference risk, and/or to take into account, for example, the degree of precision/the margin of error of the at least an anti-collision system, the precautionary angular sector can be selected at a certain angular distance, called precautionary angular distance, from the first angular sector. In other words, when the control method directs the boom of the crane until it reaches an angular sector for which the risk of collision is no longer detected (namely the first angular sector), the control method will continue the orientation movement, always in the same direction, over a certain number of degrees corresponding to the precautionary angular distance, until reaching the precautionary angular sector.

According to an embodiment of the invention, the precautionary angular distance is non-zero and configurable, and is for example comprised between 3 and 10 degrees.

In other words, such a configurable precautionary angular distance can be considered in the definition of the control method. It can for example be comprised between 3 and 10 degrees, and for example in the range of 5 degrees. If this value in variants of the control method can be a predefined fixed value, it can also be, in other variants, a value given by the operator, during the setting step of the method for example, in the mentioned value range.

According to a characteristic of the invention, during the selection sub-step, the final angular sector is selected among angular sectors, called nearby angular sectors, including the precautionary angular sector and angular sectors which are distributed over a limit angular distance given from said precautionary angular sector.

According to a characteristic of the invention, the limit angular distance is less than or equal to 360 degrees, and for example less than or equal to 180 degrees.

In other words, the control method, during the selection sub-step, will select a final angular sector where to complete the orientation movement of the crane among several angular sectors, called nearby angular sectors, comprised in a given limit angular distance from and comprising the precautionary angular sector.

The value of the limit angular distance is less than or equal to 360 degrees, thus authorizing at most one complete or almost complete turn. Alternatively, the value of the limit angular distance is less than or equal to 180 degrees, thus authorizing a maximum of a half-turn.

In a variant of the control method, this value of the limit angular distance can be predefined. In another variant, this value can be given by the operator within the range of values specified during the method setting step, for example.

According to a characteristic of the invention, during the selection sub-step, the values of the interference counters of the nearby angular sectors are compared with a minimum value and the nearby angular sector(s) having a lower interference counter value or equal to said minimum value is or are said secured nearby angular sectors, and the final angular sector is selected from said secured nearby angular sector(s).

In other words, in connection with the previous point, the limit angular distance comprises several angular sectors, called nearby angular sectors, which are all potential final angular sectors in which the control method can stop the orientation movement and position the boom. During the selection sub-step, the control method performs a first sorting of the potential candidates by comparing the value of their interference counter with a minimum interference counter value, which establishes a low threshold for which it is estimated that the risk of interference is small. The nearby angular sectors whose interference counter value is less than or equal to this minimum value are selected as promising candidates, these nearby angular sectors then being called secured nearby angular sectors.

According to a characteristic of the invention, during the selection sub-step, the minimum value corresponds to the lowest value of the interference counters of the nearby angular sectors, or to the lowest value of the interference counters of the nearby angular sectors incremented by a configurable increment value.

The minimum value serving as the first selection criterion can correspond either to the lowest value of the interference counters of the nearby angular sectors; or the lowest value of the interference counters of the nearby angular sectors incremented by a configurable incrementation value, this incrementation value possibly corresponding for example to one or two incrementation units.

In the first case, only the nearby angular sectors having the lowest value of the interference counter, that is to say for which the risk of interference is the lowest, are considered as secured nearby angular sectors. Nonetheless, and depending on the application context, this value can be relatively restrictive. For example, the near angular sector(s) with the lowest interference counter value may potentially be relatively far from the precautionary angular sector, while nearby angular sectors which are much closer to the precautionary angular sector may have a value interference counter certainly higher than the lowest interference counter value, but for which the interference risk remains low.

Yet, it is possible that these sectors are more interesting for the positioning of the boom, because they are near the sectors where the detection took place; it can be assumed that the crane was working in its starting angular sector, and that it needs to return to this sector.

The second case aims to address this drawback by offering a better compromise between positioning the boom in a secured angular sector following collision risk detection and controlling the application context (in the example given below, avoid unnecessary loss of time by allowing the crane to be able to return as quickly as possible to the angular sector in which it was working).

According to a characteristic of the invention, during the selection sub-step, the final angular sector is selected as being a secured nearby angular sector, among the secured nearby angular sectors, and which is:
either the one which is angularly closest to the angular precautionary sector;
or the one which, on the one hand, has a value of the interference counter which is equivalent to the lowest value of the interference counters of the nearby angular sectors and, on the other hand, is the angularly closest to the precautionary angular sector.

In connection with the previous point, following the application of the first selection criterion having made it possible to identify secured nearby angular sectors on the limit angular distance, the second and last criterion applied in order to determine the final angular sector is to choose the secured nearby angular sector which:
in the first case, has the lowest interference counter value and is the angularly closest to the precautionary angular sector;
in the second case, which has an interference counter value which is lower than the defined minimum value (without however corresponding to the smallest interference counter value), and which is angularly nearby to the precautionary angular sector.

In both cases, it is possible, depending on the values of the interference counters, that the selected final angular sector is the precautionary angular sector. At this moment, this means that the automatic and autonomous orientation step of the boom ends when the control method orients the boom in the precautionary angular sector. If not, the control method must orient the boom again over a certain angular distance separating the precautionary angular sector from the determined final angular sector.

According to a characteristic of the invention, during the selection sub-step, the values of the interference counters of the nearby angular sectors are compared with a maximum value and the nearby angular sector(s) having a higher interference counter value or equal to said maximum value is or are called risky nearby angular sectors, and in which the final angular sector is selected among the nearby angular sectors extending in a safe angular interval delimited, on the one hand, by the precautionary angular sector included and, on the other hand, by the risky nearby angular sector or by the first of the risky nearby angular sectors starting from the excluded precautionary angular sector; so that, during the step of automatic and autonomous orientation of the boom, the boom does not reach and does not exceed said risky nearby angular sector or said first of the risky nearby angular sectors starting from the precautionary angular sector.

According to a characteristic of the invention, during the selection sub-step, the final angular sector is selected as the nearby angular sector having the lowest value of the interference counter in the secured angular interval, independently of the values of the interference counters from nearby angular sectors located beyond said secured angular interval

When applying the first selection criterion, the values of the interference counters of the nearby angular sectors comprised in the limit angular distance are also compared with a maximum value corresponding to a threshold value for which the risk of interference between the boom and an obstacle is very high. Any angular sector with an interference counter value greater than this value is considered a risky nearby angular sector. Depending on the application context, the limit angular distance can comprise one or more risky nearby angular sectors (successive or not). The objective is for the control method to stop the orientation of the boom before reaching the first of one or more risky nearby angular sectors.

If at least one risky nearby angular sector is identified, then the control method will modify its selection criterion, by selecting as final angular sector the nearby angular sector having the smallest interference counter value among the nearby angular sector(s) comprised in a secured angular interval delimited by the precautionary angular sector and the first risky nearby angular sector that can be encountered in the direction of the orientation movement (this risky nearby angular sector being excluded from the secured angular interval). As indicated previously, according to the interference counter values of the angular sectors comprised in the safe angular range, the final angular sector may correspond to the precautionary angular sector.

According to a characteristic of the invention, during the initial segmentation step, the circular work area is segmented into at least 36 angular sectors.

According to an embodiment of the invention, the initial segmentation step, the circular work area is segmented into at least 120 isometric angular sectors.

According to an embodiment of the invention, during the initial setting step, the value of the interference counter of each of the several angular sectors is the smallest value defined in said control method.

In the design of the control method, it is at least provided that the circular work area, during the initial segmentation step, be segmented in the interference mapping at least into 36 angular sectors which may or may not be isometric.

As indicated previously, the control method offers the operator a default segmentation which he can then modify, and for which the circular work area is segmented into 120 isometric angular sectors, that is to say each having an angular distance of 3 degrees.

Also, according to a given embodiment, the control method proposes, for the initial setting step, a default setting of the interference counter values of each of the angular sectors such as in the initial operating state of the crane (t = 0), the interference counter value of all the angular sectors is the smallest defined in the method, meaning that all the angular sectors are considered initially as de-risked, and that the angular interference sectors/interference zones will be progressively identified by the control method when the risk of collision is detected by the at least one anti-collision system.

The invention also relates to a system for controlling a crane comprising a boom and at least one anti-collision system suitable for detecting a risk of collision on a right side and a left side of the boom, said boom being controllable in orientation about an orientation axis and operating in a circular work area, and in which said automatic control system is designed to contain and to execute a program comprising a list of instructions related to an implementation of a control method in accordance with one presented.

In other words, the control method presented in the context of the invention is implemented in then executed by a control system, said control system controlling the orientation movements of the crane, and being connected to the at least one anti-collision system, with which it communicates. Thus, when the at least one anti-collision system detects a risk of collision at the level of the right side or the left side of the crane, it transmits this information to the control system which will then apply the control method, by implementing the construction step, followed by the automatic orientation and selection steps. The control system is not exhaustively an electronic card, or a processor, or a controller, or a computer, or a combination of all or part of these elements.

The invention also relates to a crane comprising a boom and at least one anti-collision system suitable for detecting a risk of collision on a right side and a left side of the boom, said boom being controllable in orientation about an axis of orientation and operating in a circular work area, said crane further comprising a control system in accordance with that described above, and communicating/exchanging information with the at least one anti-collision system and with the boom to control it in rotation, either in the working state in response to commands from a crane operator, or in the automated control state.

### BRIEF DESCRIPTION OF THE DRAWINGS

Other characteristics and advantages of the present invention will appear on reading the detailed description below, of a non-limiting example of implementation, made with reference to the appended figures in which:

FIG. 1 is a schematic view of an example of a crane comprising a control system adapted for the implementation and the execution of the control method;

FIG. 2 is a flowchart describing the operating principle of the control method depending on whether the crane is in a working state or in an automated control state;

FIG. 3 is a flowchart describing the operation of the automatic and autonomous boom orientation step when the crane is in an automated control state;

FIG. 4 schematically illustrates a crane in two examples of real environment (on the left) with either one neighboring crane or three neighboring cranes, then the same crane modeled with its circular work area (center) and this same circular work area having been segmented into several angular sectors (on the right) after the initial segmentation step of the control method, it being noted that the boom is shown superimposed on this segmented circular work area;

FIG. 5 schematically illustrates an example of interference mapping resulting from the construction step of the control method, in which a value of an associated interference counter is entered for each angular sector (for reasons of clarity for the next figures, the value of the interference counter is not indicated in the interference mapping when it is equal to 0);

FIG. 6 schematically illustrates a crane, called the first crane, in an environment example (on the left) with a neighboring crane, called the second crane, where the work area is represented as segmented and where the boom of the first crane is in a starting angular segment, and an interference mapping (on the right) representative of the circular work area of this first crane, the interference counters of the angular sectors all being at zero, this prior to the step of constructing the control method, in other words before incrementing the interference counters of the angular sectors concerned in the case of detection of a risk of collision;

FIG. 7 is equivalent to FIG. 6, and follows the situation of FIG. 6 after the second crane has been oriented to the point that the collision avoidance system of the first crane detects a risk of collision, thus initiating the start of the construction step of the control method and of the automatic and autonomous orientation step of the boom of the first crane;

FIG. 8 is equivalent to FIG. 7, and comes after the situation of FIG. 7 when the second crane was stopped with its boom positioned in an angular position nearby to the starting angular sector, during the automatic and autonomous orientation step of the boom of the first crane until reaching a first angular sector for which the risk of collision is no longer detected (maneuvering step by a crane operator if the first crane is in the working state, or first orientation step if it is in automated control state), and during the construction step with real-time and parallel update of the interference mapping of the first crane;

FIG. 9 is equivalent to FIG. 7, and comes after the situation of FIG. 7 while the second crane continues its orientation (as a variant of the case of FIG. 8), during the automatic and autonomous orientation step of the boom of the first crane until reaching a first angular sector for which the risk of collision is no longer detected (step of maneuvering by a crane operator if the first crane is in the working state, or first orientation step if it is in automated control state), and during the construction step with real-time and parallel update of the interference mapping of the first crane;

FIG. 10 is equivalent to FIG. 9, and comes after the situation of FIG. 9, during the automatic and autonomous orientation step of the boom of the first crane until reaching a precautionary angular sector, beyond the first angular sector;

FIG. 11 schematically illustrates the first crane, in an example of an environmental context (on the left) with the second crane and with another neighboring crane, called the third crane, during the automatic and autonomous boom orientation step of the first crane, and more specifically during its selection sub-step, with an interference mapping (on the right) representative of the circular work area of the first crane;

FIG. 12 schematically illustrates the first crane (on the left) of FIG. 12 and its associated interference mapping (on the right), during the automatic and autonomous orientation step of the boom of the first crane until reaching a final angular sector established during the selection sub-step, having a minimum value and a maximum value of the interference counter respectively equal to 1 and 5;

FIG. 13 schematically illustrates the first crane (on the left) of FIG. 12 and its associated interference mapping (on the right), during the automatic and autonomous orientation step of the boom of the first crane until reaching a final angular sector established during the selection sub-step, having a minimum value and a maximum value of the interference counter respectively equal to 2 and 5; and

FIG. 15 schematically illustrates the first crane (on the left) of FIG. 12 and its associated interference mapping (on the right), during the automatic and autonomous orientation step of the boom of the first crane until reaching a final angular sector established during the selection sub-step, having a minimum value and a maximum value of the interference counter respectively equal to 0 and 4.

### DESCRIPTION

The control method DP which is the subject of the invention is implemented by being implemented in a control system 1c equipping a crane G, then is executed by this same control system 1c. The control system 1c comprises for example all or part of the following elements: an electronic card, a processor, a controller, a computer. It comprises for example a memory in which is loaded a program containing a list of instructions for the implementation, for example by a processor or a computer, of this control method DP.

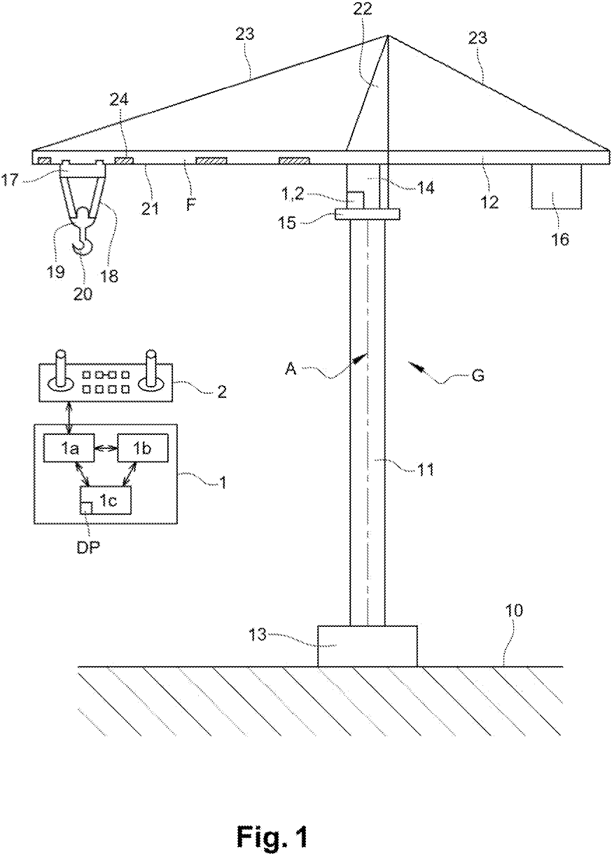

According to the proposed embodiment and with reference to FIG. 1, the control system 1c is integrated into the control/command system 1 of the crane G, which can for example be installed in a control cabin 14.

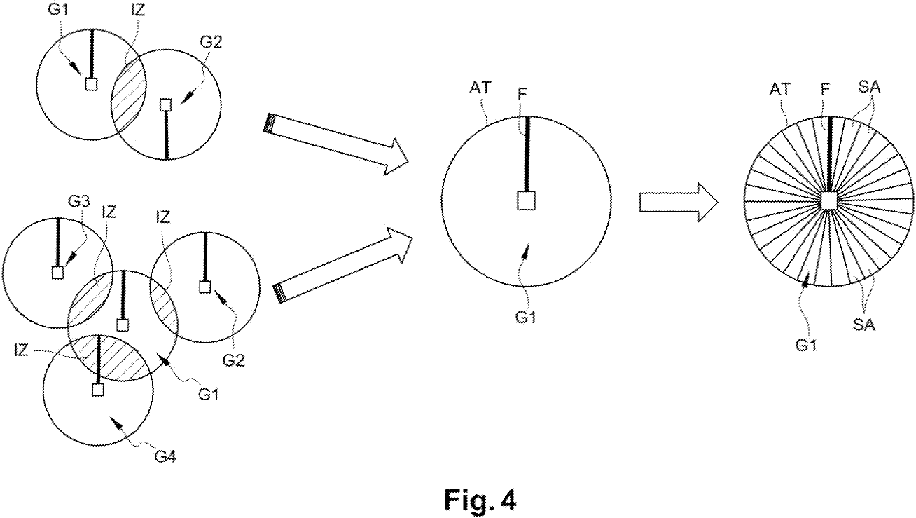

The illustrated crane G is a tower crane which comprises a mast 11 mounted on a platform 13 which can be fixed to the ground 10 or can be movable (for example by being placed on rails); and a rotating assembly formed by a boom F and a counter-boom 12 substantially aligned, and optionally a boom holder 22 (or punch) with tie rods 23, said rotating assembly being rotated about an orientation axis A, which is of vertical extension, by means of an orientation ring 15 coupled to at least one orientation motor, causing the boom F to sweep a circular zone about the orientation axis A, this circular zone corresponding to its working circular area AT shown schematically in FIGS. 4 to 14. A counterweight 16 (or ballast block) is positioned on the counter-boom 12 to counterbalance the weight of a load lifted by the crane G as well as stabilize the latter during its orientation movements.

The load is lifted by means of a hook 20 located at the end of a reeve-block 19 which is moved vertically by means of at least one lifting cable 18 attached to a distribution trolley 17 movable in translation on a rolling path 21 provided along the boom F.

In this embodiment, the control/command system 1 comprises a central unit 1a in connection with the control system 1c; the central unit 1a whose role is to orchestrate/ensure the proper functioning of the crane G and in particular the implementation of the movements of the elements of the crane (orientation of the boom, optional raising/lowering of the boom) and of the load (moving the distribution trolley, lifting the reeve-block and the load).

This central unit 1a communicates at least to the control system 1c an information relating to the current state of the crane G, which is either in a working state E2, or in an automated control state E1 or in weather vane.

The control/command system 1 comprises a collision avoidance system 1b which receives, from one or more sensors 24 disposed on the crane G, and for example on the boom F (such as for example millimetric wave radar sensors), information of detection of risk of collision between the boom F and an obstacle coming from its right side or its left side.

The central unit 1a also communicates with the at least one collision avoidance system 1b, and also receives command orders from a control panel 2 used by the crane operator in order to be able to maneuver the crane G.

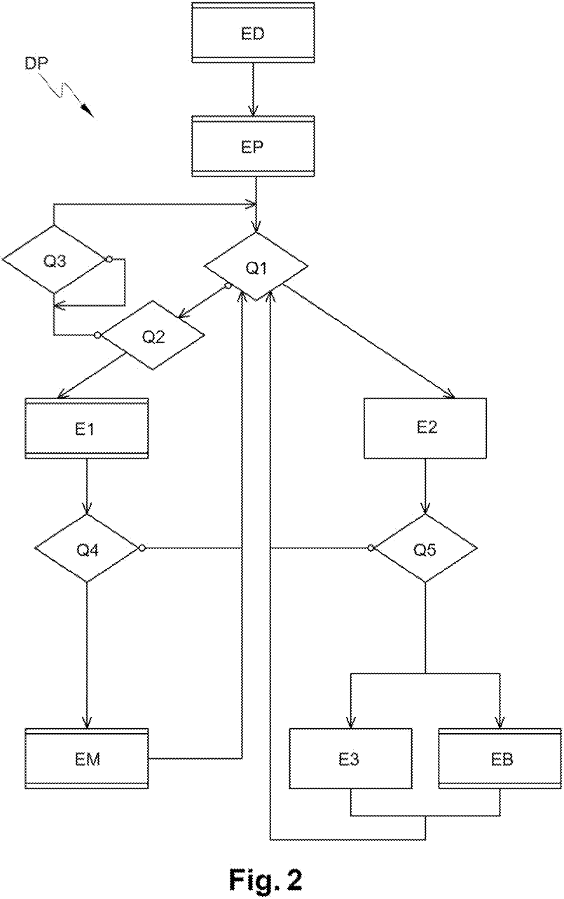

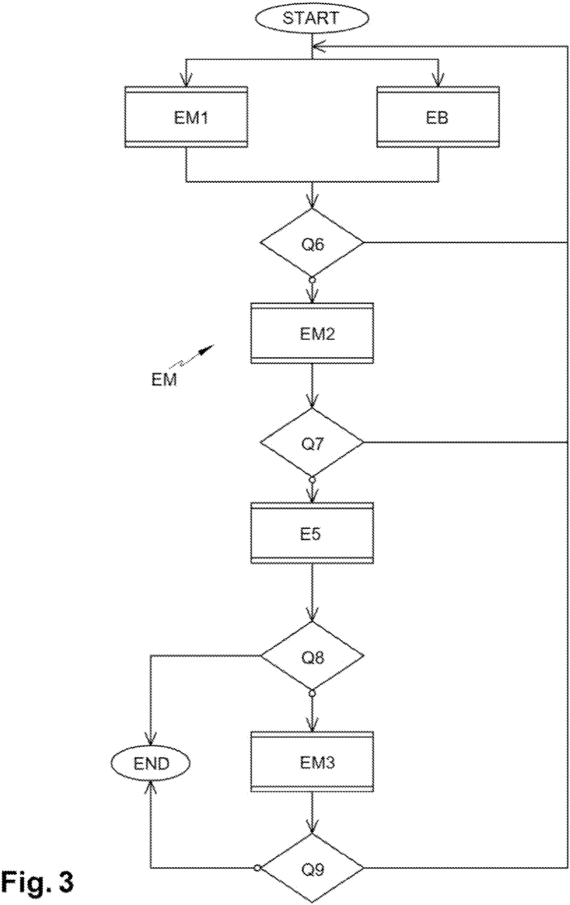

A flowchart of the control method DP is shown in FIGS. 2 and 3. Its operating principle is explained in more detail below and illustrated through several examples shown in FIGS. 4 to 14.

The control method DP is applied in the context of site environment contexts for which the boom F of a first crane G1, which is shaped to implement the control method DP and which can be in working condition or in an automated control state, can, when positioned in an angular or rotating position in its circular work area AT, interfere with different types of obstacle, for example: the boom(s) of other cranes G2 and/or G3 and/or G4, because the circular work areas AT of the first crane G1 or of said other crane(s) G2, G3, G4 overlap in interference zones IZ; buildings such that their location on the site occupies part of the area of the circular work area AT of the first crane G1.

By way of illustration, two examples of site environment context are shown in FIG. 4 (on the left). In the first example, the boom F of the first crane G1 can potentially interfere with the boom of a second crane G2. In the second example, the boom F of the first crane G1 can potentially interfere with the booms of a second crane G2, a third crane G3, and a fourth crane G4.

With reference to FIG. 2, at its start, the control method DP implements an initial segmentation step ED during which a virtual modeling of the circular work area AT of the first crane G1 is implemented (FIG. 4, center) such that it is segmented into a plurality of angular sectors SA (FIG. 4, right). It is on the basis of this virtual model that an interference mapping C is then constructed. By abuse of language, for reasons of clarity, the actual circular work area and the modeled circular work area will carry the same reference «AT» in the present description.

In this modeling, the elements of the environment external to the first crane G1 are not modeled, and in particular the neighboring cranes or other cranes G2, G3 and/or G4, or any other potential obstacle such as a building, are not represented and considered in the modeling. Thus, the interference zones IZ are also not present in the modeling of the circular work area AT, and therefore in the resulting interference mapping C.

The control method DP is defined such that it is expected that the virtual model of the circular work area AT of the first crane is at least segmented into 36 angular sectors SA. In a preferred embodiment, the circular work area AT is segmented into 120 isometric angular sectors SA (that is to say each making 3 degrees). According to different embodiments, either the number of angular sectors SA defined in the virtual model is fixed by the designers of the control method DP, or it can be configured by an operator through an option offered by a software accessible from the control/command system 1 (in which case the operator must validate his settings so that the control method can continue).

For reasons of clarity and understanding of the operating principle of the control method DP, the circular work area AT of the first crane G1 is segmented into 32 isometric angular sectors in FIGS. 4 to 14.

Following the initial segmentation step ED, the control method implements an initial setting step EP during which it constructs, from the virtual model, an interference mapping C which in fine, and over the course of the actions subsequently carried out by the control method DP, will be representative of the heterogeneity of a real risk of interference IR between the boom F of the first crane G1 and the obstacle(s) in the entire surface of the circular work area AT described by the boom F.

For this, the control method DP associates with each of the angular sectors SA, segmenting the circular work area AT, an interference counter Cpt which can take a value Cptval representative of a level of risk of interference IR such as: the smaller the Cptval value, the lower the risk of interference IR between the boom F of the first crane G1 and an obstacle; and conversely, the larger the Cptval value of the interference counter Cpt, the greater the risk of interference IR.

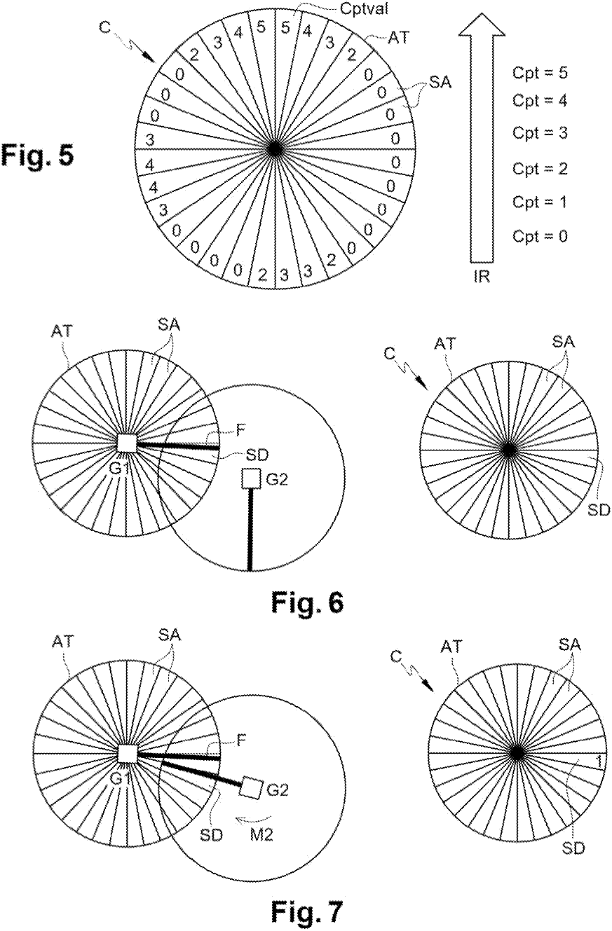

The range of values that can be taken by the value Cptval may be different according to several possibilities of realization, depending on the level of risk IR that the designers associate with a value. In the presented embodiment, the interference counter Cpt can take at least six integer values of Cptval ranging from 0 to 5, such that the level of risk of interference IR is: zero when the value Cptval is equal to 0, very low when equal to 1, low when equal to 2, medium when equal to 3, high when equal to 4, and very high when equal to 5. An example of interference mapping C is illustrated in FIG. 5. It is possible in other embodiments for the range of values Cptval to be wider, or on the contrary narrower.

By default, during the initial setting step EP, the control method DP constructs the interference mapping C such that the interference counter Cpt of each of the angular sectors SA is equal to the lowest value Cptval. According to two variants, either this step is entirely automated, or the operator has the option of modifying the values Cptval given by default by the control method. Indeed, the operator can have a more or less fine knowledge of the real context of the circular area AT of the first crane G1, and therefore be able to associate for all or part of the angular sectors SA represented in the interference mapping C an appropriate value Cptval. This second variant assumes that the operator validates his own settings so that the control method DP can continue.

The control method is implemented when the first crane G1 is either in a working state E2 (which is the state in which the control is exercised manually by a crane operator) or in an automated control state E1.

Also, with reference to FIG. 2, following the initial setting step EP, the control method DP identifies in which state the first crane G1 is, for example by means of an information transmitted for example by the central unit 1a to the control system 1c, during two identification phases Q1, Q2 such as:
During a first identification phase Q1, the first crane G1 is identified as being or not in the working state E2, in other words controlled by a crane operator;
If not, during a second identification phase Q2, the first crane G1 is identified as being or not in the automated control state E1;
If not, the control method considers the first crane G1 as being in a weather vane state, and waits during a waiting phase Q3 for this state to change.

For reasons of clarity and understanding of the operating principle of the control method DP, for the next figures illustrating application examples:
The environmental context is presented in the figure on the left, the interference mapping C of the first crane G1 is shown on the right;
In the schematic representation of the environmental context, the circular work area AT of the first crane G1 is represented as segmented, with its boom superimposed;
In the interference mappings C, when the value Cptval of the interference counter Cpt of an angular sector SA is equal to 0, the value Cptval is not represented in said angular sector SA.

The interference mapping C is constructed/updated in real time as the at least one anti-collision system 1b of the first crane G1 detects a risk of collision between the boom F and an obstacle during a construction step EB.

This construction step EB is triggered when, depending on whether the first crane G1 is in an automated control state E1 (respectively a working state E2), the control method DP receives, from the at least one anti-collision system 1b or of the central unit 1a, during a receiving step Q4 (respectively Q5) of an information on the detection of a collision risk. Otherwise, the control method DP remains in the waiting/standby state if it does not receive such information representative of a detection of a collision risk.

The construction step EB is therefore implemented following the detection of a collision risk and in parallel with:
In the case where the first crane G1 is in an automated control state, an automatic and autonomous orientation step of the boom EM,
In the case where it is in a working state E2, an avoidance maneuver E3 by the crane operator to avoid colliding with the boom of the second crane (this avoidance maneuver E3 can be operated manually or alternatively automatically).

In both cases, the step of automatic and autonomous orientation of the boom EM and the avoidance maneuver E3 consist in moving the boom F of the first crane G1 according to an orientation movement M1 from its starting angular position, for which the risk of collision has been detected by the at least one anti-collision system 1b, until reaching (or exceeding) a first angular position for which the risk of collision is no longer detected by said at least one anti-collision system.

The orientation movement M1 is such that its direction is opposite to the side of the boom F of the first crane G1 for which the risk of collision has been detected: clockwise for a detection of risk of collision arriving towards the left side, direction anticlockwise for collision risk detection arriving on the right side

The construction step EB is more precisely illustrated by means of the example presented in FIGS. 6 to 9, for which the circular work area AT of the first crane G1 partially overlaps in an interference zone IZ the circular work area of a second neighboring crane G2. The first crane G1 is either in an automated control state E1, or in a working state E2; the second crane G2 is in a working state.

Referring to FIG. 6, the first crane G1 and the second crane G2 are both in two angular positions such that they are not in interference. The boom F of the first crane G1 is considered to be in a starting angular position comprised in an angular sector called the starting angular sector SD. The interference mapping C representative of the first crane G1 is such that the value Cptval of the interference counters Cpt of all the angular sectors SA, including the starting angular sector SD, are equal to 0.

Referring to FIG. 7, the second crane G2 moves according to an orientation movement M2 in the clockwise direction such that the at least one anti-collision system 1b of the first crane G1 detects a risk of collision arriving from the right side of the boom. At the time of detection, the control method DP initiates the implementation of the construction step EB by incrementing in the interference mapping C the value Cptval of the interference counter Cpt of the starting angular sector SD.

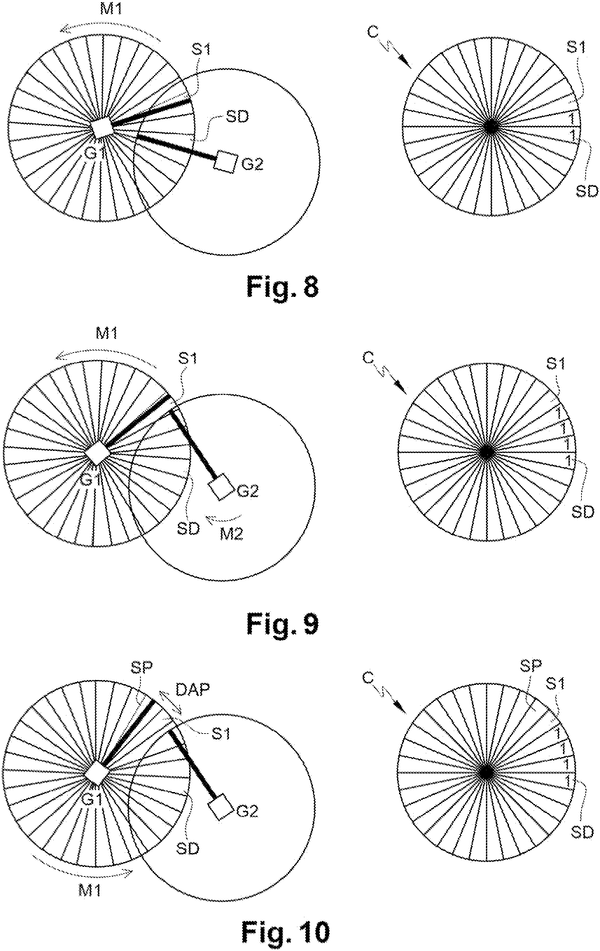

Following the situation of FIG. 8, the second crane G2 continues its orientation movement M2, while the first crane G1 is oriented according to the orientation movement M1 during the automatic and autonomous orientation step of the boom EM (or an avoidance maneuver E3) until reaching the first angular position for which the risk of collision is no longer detected, the values Cptval of the interference counters of the angular sectors SA crossed by the boom F of the first crane G1 and for which the risk of collision still continues to be detected are incremented in the interference mapping C. This means that the value Cptval of the interference counter Cpt of the angular sector SA comprising the first angular position for which the risk of collision is no longer detected where the boom F of the first crane G1 is placed, called the first angular sector S1, is not incremented.

The update of the interference mapping C is stored by the control method DP.

Note that depending on the application situation, in particular when the first crane G1 is in automated control state E1, and as illustrated by FIG. 8, the boom F of the first crane G1 can be positioned in a first angular sector S1 which is comprised in an interference zone with another crane, as long as the risk of collision is no longer detected.

Such an interference mapping C is of interest to the crane operator because it allows him to be informed of the presence of a risk zone in which to work and/or position the boom, and the latter is particularly advantageous when the first crane G1 is in an automated control state E1, and that the control/command system 1 must automatically and completely autonomously position the boom in a secured angular position or for which the risk of interference/collision with an obstacle is low.

According to a variant, when the first crane G1 is in an automated control state E1, the automatic and autonomous orientation step of the boom EM can only consist of the orientation movement M1 described above. In this case, the first angular sector S1 corresponds to a final angular sector SF in which the boom F of the first crane G1 remains positioned once the risk of collision is no longer detected. Also, it can be considered that the first angular sector S1 corresponds to the final angular sector following the avoidance maneuver E3 of the crane operator, when the first crane G1 is in a working state E2.

According to other variants, additional automatic steps can be implemented. As such, the flowchart describing the automatic and autonomous orientation step of the boom EM in FIG. 3 comprises all the provided automatic steps.

The step of automatic and autonomous orientation of the boom EM thus comprises a first orientation sub-step EM1, which is imposed, consisting of the orientation movement M1 of the boom F of the first crane G1 described so far, from the starting angular sector SD, where a risk of collision has been detected, to the first angular sector S1, where the risk of collision is no longer detected; the orientation movement being carried out in the opposite direction to the side of the boom F where the risk of collision was detected. The construction step EB for the construction in real time of the mapping representative of the level of risk of interference IR in the circular work area AT of the first crane G1 is carried out in parallel with this first orientation sub-step EM1.

Following this orientation sub-step EM1, the automatic and autonomous orientation step of the boom EM comprises a second orientation sub-step EM2 during which the control method DP continues the orientation movement M1 of the first crane G1 from the first angular sector S1 over an angular distance called the precautionary angular distance DAP. The angular sector in which the boom F of the first crane G1 is positioned is then called the precautionary angular sector SP located at the precautionary angular distance DAP from said first angular sector S1.

This second orientation sub-step EM2 is implemented so that an additional safety margin is left to further minimize the risk of collision between the boom F of the first crane G1 and the detected obstacle (here the boom of the second crane G2), or even to take account, for example, of the degree of precision/of the margin of error of the at least one anti-collision system 1b. It is illustrated in FIG. 10, which is equivalent to and follows the situation in FIG. 9.

According to different embodiments of the invention, the angular precautionary distance DAP can either be fixed by the designers of the invention or be configurable, for example through a setting implemented by the operator during the initial setting step EP. It can for example be comprised between 3 degrees and 10 degrees. In a preferred embodiment, the precautionary angular distance DAP is equal to 3 degrees. Depending on the angular distance defining the first angular sector S1, the angular position of the boom F of the first crane G1 in said first angular sector S1, and the value of the precautionary angular distance DAP, it remains possible that after displacement of the boom F on the precautionary angular distance DAP, the boom is always comprised in the first angular sector S1.

In this case, the first angular sector S1 is considered to be the precautionary angular sector SP. In the preferred embodiment, for which the angular distance of all the angular sectors is equal to 3 degrees and therefore to the precautionary angular distance DAP, the precautionary angular sector SP corresponds to the adjacent angular sector SA downstream to the first angular sector S1 in the direction of the orientation movement M1 of the boom F of the first crane G1.

Optionally, the control method DP can also implement a third orientation sub-step EM3 consisting in continuing the orientation movement M1 of the boom F of the first crane G1 from the angular precautionary sector SP (or of the first angular sector S1 if the second orientation sub-step EM2 is not implemented in the control method DP) until reaching an angular sector called the final angular sector SF, for which the risk of interference between the boom F and an obstacle is weak or even non-existent.

Upstream of this third orientation sub-step EM3, a selection sub-step ES is performed during which the control method DP will determine/select the final angular sector SF according to various criteria.

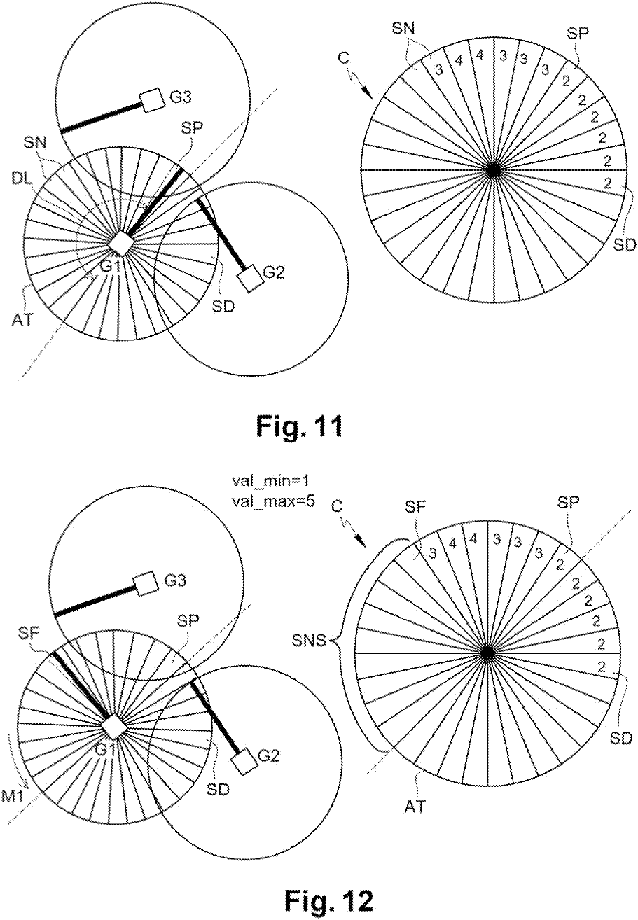

The selection sub-step ES and the third orientation sub-step EM3 are illustrated by means of FIGS. 11 to 14, for which an application context is considered (figures on the left) where the first crane G1, whose boom is positioned in the precautionary sector SP, there are interference zones with the second crane G2 and also a third crane G3, both of which are in a working state.

The interference mapping C representative of the circular work area AT of the first crane G1 is illustrated in the figures on the right, said circular area being represented as segmented into angular sectors, with its boom F superimposed, for explanatory purposes.

With reference to FIG. 11, the final angular sector SF is selected among several angular sectors called nearby angular sectors SN, which are comprised in a limit angular distance DL defined as being non-zero and less than or equal to 360° from the precautionary angular sector SP included.

In the shown embodiment, the limit angular distance DL is equal to 180°. This means that, depending on the result from the selection sub-step ES, the final angular sector SF can correspond to the precautionary angular sector SP (or to the first angular sector S1 if the second orientation sub-step EM2 is not implemented in the control method DP), in which case the control method DP does not proceed to the third orientation sub-step EM3. The control method DP verifies whether this situation is encountered during a verification phase Q8, taking place between the selection sub-step ES and the third orientation step EM3.

During the selection sub-step ES, the control method DP compares the value Cptval of the interference counter Cpt of each of the nearby angular sectors SN with a minimum value val_min and a maximum value val_max, both integers and comprised in the range of values that Cptval can take. In the presented embodiment, the minimum value val_min and the maximum value val_max are comprised in the integer interval [0,5].

The value val_min corresponds to a threshold for which any nearby angular sector SN having a lower or equal value Cptval of interference counter is considered to be a secured nearby angular sector SNS, that is to say a nearby angular sector SN for which the risk of interference IR is low, even zero.

Conversely, the value val_max corresponds to a threshold for which any nearby angular sector SN having an equal or greater value Cptval of interference counter is considered to be a risky nearby angular sector SR, that is to say a nearby angular sector SN for which the risk of interference IR is high or very high.

According to different variants, either the minimum value val_min and maximum value val_max as well as the limit angular distance DL are fixed by the designers, or they may be optionally defined by the operator during the initial setting step EP. By default, according to a first variant of the invention, the minimum val_min and maximum val_max values may correspond respectively to the lowest and to the highest of the values Cptval that the interference counters Cpt may take.

In a second alternative embodiment, the minimum value val_min could correspond to a percentage of the difference between the highest and the lowest of the values Cptval of the interference counter Cpt, the minimum value val_min being rounded off to the nearest unit if the difference is not an integer value. For example, the minimum value val_min is respectively equal to 2 or 3 if the difference between the highest and the lowest value Cptval is equal to 2.4 or 2.8. Note that if the difference is equidistant from two units, the minimum value val_min would be equal to the largest of the units. For example, if the difference is equal to 2.5, then the minimum value val_min is equal to 3. The minimum value val_min and the maximum value val_max may also be modified/adapted automatically in the case that no secured nearby angular sector SNS is identified among the one or more nearby angular sectors SN (see below)

When no nearby angular sector SN is a risky nearby angular sector SR, the final angular sector SF is selected such that it corresponds to the nearest first secured nearby angular sector SNS, in the orientation direction M of the boom F of the first crane G1, of the precautionary angular sector SP included.

In the example illustrated in FIG. 12, for which the minimum value val_min and the maximum value val_max are considered to be equal to 1 and 5 respectively, the secured nearby angular sectors SNS correspond to the nearby angular sectors SN whose value Cptval of interference counter is less than or equal to 1, namely here those having a value Cptval of zero or equal to 1. The precautionary angular sector SP is not part of these secured nearby angular sectors SNS, because it has a value Cptval equal to 2. Consequently, the automatic control method continues the orientation movement of the boom F of the first crane G1 from the precautionary angular sector SP (or from the first angular sector S1) to the final angular sector SF, which here corresponds to the first secured nearby angular sector SNS having zero value Cptval of interference counter Cpt in the orientation movement direction M1;

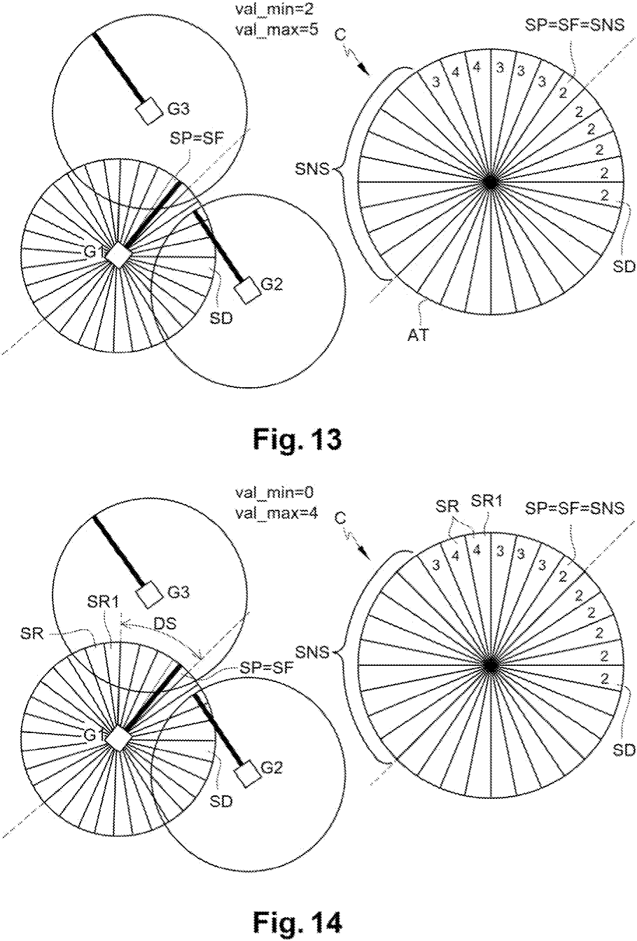

In the example illustrated in FIG. 13, for which the application context of FIG. 12 is repeated but this time for a minimum value val_min and a maximum value val_max equal to 2 and 5 respectively, the secured nearby angular sectors SNS correspond to the nearby angular sectors SN whose value Cptval of interference counter Cpt is less than or equal to 2, namely here the nearby angular sectors SN having a value Cptval zero or equal to 1 or equal to 2. In this application context, the control method DP does not implement the third orientation step EM3, having determined that the final angular sector SF corresponds to the precautionary angular sector SP, since it has a value Cptval equal to 2.

In the case where the limit angular distance DL does not contain any secured nearby angular sector SNS, the control method DP can increment the minimum value val_min until it identifies one or more secured nearby angular sectors SNS in the limit angular distance DL.

With reference to FIG. 14 for which the application context of FIG. 12 is repeated and for which the minimum value val_min and the maximum value val_max are respectively equal to 0 and 5, when the nearby angular sectors SN comprise one or more risky nearby angular sectors SR, the operating principle of the control method is defined such that the boom F of the first crane G1 must not cross the risky nearby angular sector SR or the first sector of the risky nearby angular sectors SR1 encountered in the orientation movement M1, even if secured nearby angular sectors SNS are situated downstream of the risky nearby angular sector SR or of the first sector of the risky nearby angular sectors SR1.

According to the same principle as previously, the control method DP then seeks to determine a final angular sector SF among secured nearby angular sectors SNS no longer comprised in the limit angular distance DL, but in a new angular interval, called the secured angular interval DS, including the precautionary angular sector SP (or the first angular sector S1) and excluding the risky nearby angular sector SR or the first sector of the risky nearby angular sectors SR1.

In the case that the secured angular interval DS does not contain any secured nearby angular sector SNS, the control method DP increments the minimum value val_min until one or more secured nearby angular sectors SNS are identified in the secured angular interval DS. This situation is presented in FIG. 14, for which there is no secured nearby angular sector SNS in the secured angular interval DS such as having a value Cptval of interference counter Cpt of zero. Following two successive increments, the control method DP succeeds in identifying a single secured nearby angular sector SNS having a value Cptval of the interference counter Cpt equal to 2, and which corresponds to the precautionary angular sector SP in the illustrated example. The control method DP then considers that the precautionary angular sector SP corresponds to the final angular sector SF (and consequently does not implement the third orientation sub-step EM3).

During the orientation sub-steps EM1, EM2, EM3, the control method DP verifies during reception phases Q6 (before the second orientation sub-step EM2), Q7 (before the selection sub-step ES) and Q9 (before the third orientation sub-step EM3) if it has received information representative of a detection of a risk of collision. If so, the control method DP resumes from the beginning and repeats the boom automatic and autonomous orientation step EM.

1-17. (canceled)

18. A control method for controlling a crane comprising a boom and at least one anti-collision system adapted to detect a risk of collision on a right side and a left side of the boom, the boom being controllable in orientation about an orientation axis and operating in a circular work area, for which the crane is either:
in a working state for which a manual controlling of the orientation of the boom is implemented by a crane operator, or
in an automated control state for which an automated controlling of the orientation of the boom is implemented;
the control method implementing at least the following steps:
an initial segmentation step during which the circular work area is segmented into several angular sectors;
an initial setting step during which each of the several angular sectors is associated with an interference counter representative of a level of risk of interference in the angular sector associated between the boom and an obstacle; and
a construction step during which, the crane being either in the working state or in the automated control state, whether the boom is moving or not, and each time the boom is present in an angular sector among the several angular sectors, and the at least one anti-collision system detects a risk of collision in the angular sector, then a value of the interference counter in the angular sector is incremented, thus constructing in real time an interference mapping in which the several angular sectors present interference counters having values which are distinct and scalable.

19. The control method according to claim 18, wherein, when the crane is in the automated control state, the automated controlling of the orientation of the boom is implemented as a function of the interference mapping.

20. The control method according to claim 19, wherein, during the automated controlling, each time the boom is present in an angular sector, called starting angular sector, among the several angular sectors, and that the at least one anti-collision system detects a risk of collision in the starting angular sector, an automatic and autonomous orientation step of the boom is implemented during which the boom is oriented from the starting angular sector in a direction opposite to the right or left side for which the risk of collision is detected, until the boom is automatically stopped in a final angular sector which is an angular sector in which the at least one anti-collision system does not detect any risk of collision, said automatic and autonomous orientation step of the boom comprising a selection sub- step during which is selected the final angular sector among the several angular sectors according to the values of their respective interference counters.

21. The control method according to claim 20, wherein, during the automatic and autonomous orientation step of the boom, the boom is oriented from the starting angular sector until reaching or exceed a precautionary angular sector, the precautionary angular sector corresponding:
either to the angular sector, called first angular sector, for which the at least one anti-collision system no longer detects a risk of collision during the automatic and autonomous orientation step of the boom from the starting angular sector;
or to an angular sector located at a precautionary angular distance from the first angular sector.

22. The control method according to claim 21, wherein the precautionary angular distance is non-zero and configurable between 3 and 10 degrees.

23. The control method according to claim 21, wherein, during the selection sub-step, the final angular sector is selected from among angular sectors, called nearby angular sectors, including the precautionary angular sector and angular sectors which are distributed over a given limit angular distance from the precautionary angular sector.

24. The control method according to claim 23, wherein the limit angular distance is less than or equal to 180 degrees.

25. The control method according to claim 23, wherein, during the selection sub-step, the values of the interference counters of the nearby angular sectors are compared to a minimum value and the nearby angular sector(s) having an interference counter value less than or equal to said minimum value is or are called secured nearby angular sectors, and the final angular sector is selected from secured nearby angular sector(s).

26. The control method according to claim 25, wherein, during the selection sub-step, the minimum value corresponds to the lowest value of the interference counters of the nearby angular sectors, or at the lowest value of the interference counters of the nearby angular sectors incremented by a configurable increment value.

27. The control method according to claim 26, wherein, during the selection sub-step, the final angular sector is selected as being a secured nearby angular sector, among the secured nearby angular sectors, and which is:
either the one that is angularly closest to the angular precautionary sector;
or the one which, on the one hand, has a value of the interference counter which is equivalent to the lowest value of the interference counters of the nearby angular sectors and, on the other hand, is the closest angularly to the precautionary angular sector.

28. The control method according to claim 25, wherein, during the selection sub-step, the values of the interference counters of the nearby angular sectors are compared with a maximum value and the nearby angular sector(s) having an interference counter value greater than or equal to the maximum value is or are the risky nearby angular sectors, and in which the final angular sector is selected among the nearby angular sectors extending in a delimited secured angular interval, on the one hand, by the precautionary angular sector included and, on the other hand, by the risky nearby angular sector or by the first of the risky nearby angular sectors starting from the excluded precautionary angular sector; so that, during the automatic and autonomous orientation step of the boom, the boom does not reach and does not exceed the risky nearby angular sector or the first of the risky nearby angular sectors starting from the precautionary angular sector.

29. The control method according to claim 28, wherein, during the selection sub-step, the final angular sector is selected as the nearby angular sector having the lowest value of the interference counter in the secured angular interval, independently of the values of the interference counters of the nearby angular sectors located beyond said secured angular interval.

30. The control method according to claim 18 wherein, during the initial segmentation step, the circular work area is segmented into at least 36 angular sectors.

31. The control method according to claim 30, wherein, during the initial segmentation step, the circular work area is segmented into at least 120 isometric angular sectors.

32. The control method according to claim 18, wherein, during the initial setting step, the value of the interference counter of each of the several angular sectors is the smallest value defined in the control method.

33. A control system for controlling a crane comprising a boom and at least one anti-collision system adapted to detect a risk of collision on a right side and a left side of the boom, the boom being controllable in orientation about an orientation axis and operating in a circular work area, the control system communicating/exchanging information with the at least one anti-collision system and controlling the boom, and in which the automatic control system is designed to contain and to execute a program comprising a list of instructions related to an implementation of a control method in accordance with claim 18.

34. A crane comprising a boom and at least one anti-collision system adapted to detect a risk of collision on a right side and a left side of the boom, the boom being controllable in orientation about an orientation axis and operating in a circular work area, the crane further comprising a control system according to claim 33 and communicating/exchanging information with the at least one anti-collision system and with the boom to control the boom in rotation, either in the working state in response to commands from a crane operator, or in the automated control state.
